(19) United States
(12) Patent Application Publication
(10) Pub. No.: US 2024/0183477 A1
(43) Pub. Date: Jun. 6, 2024

(54) Lining Hose, Curing Device, System and Method for Trenchless Pipe Renovation

(71) Applicant: TRELLEBORG SEALING PROFILES GERMANY GMBH, Großheubach (DE)

(72) Inventors: Matthias PEPPEL, Budifingen (DE); Jörg VOGT, Bochum (DE)

(21) Appl. No.: 18/283,726

(22) PCT Filed: Mar. 24, 2022
(86) PCT No.: PCT/EP2022/057764

§ 371 Date: Sep. 22, 2023

(30) Foreign Application Priority Data
Mar. 24, 2021 (DE) 10 2021 107 399.5

(51) Int. Cl. F16L 55/165

(52) U.S. Cl. CPC F16L 55/1652; F16L 55/1656

(57) ABSTRACT

The invention relates to a lining hose (1) for trenchless renovation of a conduit or pipe (2) laid underground, having at least one fabric or nonwoven layer (5) which is impregnated or saturated with a curable liquid resin. The object of the invention is to provide an approach for trenchless renovation of conduits or pipes, said approach being improved in comparison to the prior art, in particular a more energy-efficient and inexpensive approach. The invention achieves this object in that the resin can be thermally cured and contains magnetic nanoparticles. The resin that contains nanoparticles can be converted into a thermosetting plastic by applying an alternating magnetic field. The invention also relates to a corresponding curing device with a magnetic field generator (13) and to a system and a method for trenchless renovation of conduits or pipes.

The invention relates to a lining hose for renovating a conduit or pipe laid underground or above ground, optionally also inside a building, having at least one fabric or nonwoven layer impregnated or saturated with a curable liquid resin.

The invention also relates to a curing device for curing a lining hose inserted in a conduit or pipe to be renovated, which is laid underground or above ground, optionally also inside a building, having at least one generator that can be introduced into the conduit or pipe and can be controlled from outside the conduit or pipe, i.e. from above ground, for example.

The invention further relates to a system and a method for renovating a conduit or pipe laid underground or overground, optionally also inside a building, which is used to transport a fluid (e.g. water, gas or air).

The trenchless renovation of conduits or pipes comprises different technologies to maintain the underground infrastructure of supply and disposal lines. This mainly involves repairing leaks due to age damage to pipelines and wastewater conduits. Renovation without trenches is characterized by the fact that no roads or pavements have to be broken up. Accordingly, renovation techniques without trenches are cost-effective. Residents are less inconvenienced by trenchless renovations and disruption to road traffic is limited. No earth has to be excavated, meaning that tree roots are spared.

In a common and proven method of pipe and conduit renovation without trenches, a flexible lining hose is pulled or inverted into the conduit or pipe to be renovated by means of a fluid, preferably compressed air, and a corresponding device. This has a fabric or nonwoven layer of fibrous material impregnated or saturated with a liquid resin. Often, a UV-curable resin is used, i.e. a resin in which the cross-linking process to convert the resin into a thermosetting plastic is activated by the irradiation of UV light. The lining hose is applied to the inner wall of the conduit or pipe after it has been inserted into the conduit or pipe, e.g. by means of compressed air. The resin is then cured by passing a curing device through the inside of the conduit or pipe, e.g. from the main line of a wastewater conduit. The device typically comprises one or more flexibly coupled UV modules, each comprising a UV light source and the associated electrics and electronics. The UV light emitted by the UV light sources of the UV modules irradiates the lining hose applied to the inner wall of the conduit or pipe, which cures the resin. Depending on the pipe diameter, UV light sources of different intensities are used.

The use of UV light-curable resins in lining hoses for pipe and conduit renovations without trenches has indeed proved successful. However, this technology also has disadvantages. A significant disadvantage is that the UV light is absorbed in the material of the lining hose. This means that the resin located in radially outer areas of the lining hose is exposed to less UV light than in radially inner areas. This may result in uneven or even incomplete curing. This in turn can lead to undesirable stresses in the cured lining. Another disadvantage is that the UV light must be generated at a high intensity so that the resin is reliably activated and cures through the entire thickness of the fabric or nonwoven layer. This is associated with very high energy consumption. In addition, heat is generated during the UV light-activated curing process. This is an exothermic process. The UV light sources used also produce a lot of heat. Overall, this results in considerable heating of the conduit or pipe to be renovated, which can lead to damage. For example, the conduit or pipe or the lining hose may be distorted. Local overheating or even scorching of the lining hose can easily occur.

Against this background, the object of the invention is to demonstrate an improved approach to conduit or pipe renovation.

The invention achieves this object on the basis of a lining hose of the type indicated at the outset in that the resin is thermally curable and contains magnetic particles, in particular nanoparticles.

The invention is based on the use of a commercially available thermally curable resin with magnetic particles mixed in. The resin can be specifically heated via the magnetic particles by applying an alternating magnetic field to it. Heating activates the cross-linking process and the resin is converted into a thermosetting plastic. The alternating magnetic field can reach the resin in the fabric or nonwoven layer of the lining hose much better than the conventionally used UV radiation. The alternating magnetic field penetrates insulating material without significant absorption. Reliable and uniform curing of the layer containing the resin is possible within a short time with considerably less energy input than conventionally using UV light. The heating rate can be adjusted by the amount of particles added to the resin.

According to the invention, the heat required for curing is only generated where it is needed, namely within the fabric or nonwoven layer containing the resin, where the particles convert the energy contained in the alternating magnetic field into heat. Surrounding structures are not heated. The principle is similar to that of an induction cooker, where only the bottom of the pot is heated by the alternating magnetic field, but not the glass ceramic plate on which the pot is placed. Accordingly, there is no risk of overheating or even scorching of surfaces with the lining hose according to the invention.

The principle of the invention can also be implemented (by choosing a suitable curable resin material) in such a way that curing is achieved by frontal polymerization. There is only a short activation by the alternating magnetic field. This single energy input triggers a chemical cascade, whereupon the polymerization reaction leading to curing spreads in the form of a moving front in the resin-impregnated fabric or nonwoven layer. The exothermic effect of the curing process is exploited. When curing has started locally due to the magnetic field, the heat released there also triggers curing in the surrounding area. A chain reaction is created. With this approach, the energy input for curing is minimal. Only a small amount of magnetic particles or nanoparticles need to be added to the resin.

In a preferred embodiment, the fabric or nonwoven layer is surrounded by an outer film that comes into contact with the inner wall of the conduit or pipe to be renovated. The outer film provides mechanical protection for the lining hose and improves the sliding of the lining hose when it is pulled into a conduit or pipe to be renovated.

Further preferred is an embodiment in which the fabric or nonwoven layer encloses an inner film that comes into contact with a fluid flowing in the conduit or pipe to be renovated. The inner film protects the resin-impregnated fabric or nonwoven layer on the inside of the lining hose. The inner film should be resistant to the fluid flowing in the conduit or pipe (e.g. wastewater) and should be made of an electrically non-conductive material to ensure that the alternating magnetic field can pass through it unhindered and that no eddy currents are induced.

In an advantageous design, the magnetic particles have a Curie temperature of less than 250° C., preferably less than 200° C. Above the Curie temperature, the particles lose their magnetic properties. Accordingly, above the Curie temperature there is no (further) heating by the alternating magnetic field. Accordingly, it is ensured that the lining hose does not overheat during curing.

Preferably, the particles are magnetic nanoparticles with a diameter of less than 100 nm, preferably less than 50 nm, particularly preferably less than 20 nm. Magnetic nanoparticles suitable for the invention contain MnₓZn₁₋ₓFe₂O₄ or consist of this compound. The parameter x, the value of which can be between 0 and 1, indicates the ratio of manganese to zinc. Such magnetic nanoparticles are well suited for heating and curing the resin according to the invention. The Curie temperature is in the range mentioned above and can be adjusted to the curing temperature of the resin by varying the ratio of Mn to Zn (parameter x). By varying x in the range between 0.4 and 0.7, the Curie temperature can be set between 100° C. and 250° C. The curing temperature of most thermally curable resins is in the range between 80° C. and 150° C. It can be useful to set the Curie temperature of the nanoparticles slightly above (e.g. 50° C. above) the optimal curing temperature, because the magnetic properties already decrease significantly below the Curie temperature. In this way, it can be ensured that sufficient and efficient heating up to the curing temperature takes place, but also that overheating of the lining hose is reliably prevented.

The nanoparticles can have surface functionalization, e.g. by coating with bisphenol A diglycidyl ether (BADGE). This ensures good dispersibility of the nanoparticles in the resin.

The thermally curable resin can advantageously be a commercially available, inexpensive epoxy resin. However, other thermally curable resins are also suitable, depending on the requirements.

According to a further aspect, the invention relates to a curing device for curing a lining hose inserted into a conduit or a pipe, having at least one generator that can be introduced into the conduit or the pipe, can be controlled from outside the pipe, in particular from above ground, and is designed to generate an alternating magnetic field that penetrates the lining hose. Such a curing device is suitable for curing the lining hose described above. Instead of the conventionally used UV light sources, according to the invention a field generator is used that generates an alternating magnetic field inside the conduit or pipe, which penetrates the lining hose such that the resin containing magnetic particles or nanoparticles is heated and thus cured. An alternating magnetic field generator can be achieved with little technical effort. This is technically significantly less complex and thus more cost-effective than a conventional UV curing device. The alternating field generator also has a virtually unlimited service life, unlike UV curing devices, where the rapidly ageing UV lamps have to be replaced regularly. The power supply and control can be easily carried out via a suitable cable connection from outside the conduit or pipe.

In a preferred embodiment, the generator generates the magnetic field at a frequency between 100 kHz and 1 MHz, preferably between 200 kHz and 800 kHz, particularly preferably between 300 KHz and 600 kHz. It is shown that in this frequency range, effective heating of the resin leading to curing occurs through absorption of the energy from the alternating magnetic field by the nanoparticles. Such frequencies can be generated in a technically simple and practicable manner by one or more magnetic field coils, e.g. in the form of solenoid coils, which are supplied from an alternating current source operating at the corresponding frequency. The resin is heated particularly effectively when the alternating magnetic field at the location of the lining hose, or more precisely at the location of the fabric or nonwoven layer impregnated or saturated with the resin, is in the range 1-50 mT, preferably 5-20 mT. Such a magnetic field strength can be generated with simple technical means.

Expediently, the curing device has guide means for guiding the generator on the inside of the lining hose. inserted into the conduit or pipe to be renovated. These can be rollers or runners, such as those used in conventional UV curing devices. The curing device guided in the conduit or pipe may, for example, be pulled through the conduit or pipe by traction means to cure the lining hose, wherein the speed is selected such that sufficient heating occurs at each location along the lining hose. The curing device can also be self-propelled.

Possible embodiments of the curing device are characterized by at least one camera for inspecting the inside of the conduit or pipe lined with the lining hose, and/or at least one temperature sensor for detecting the temperature at the inner surface of the lining hose. The camera is suitable for tracking and monitoring the movement of the lining hose in the conduit from above ground. The temperature sensor can be used to monitor and document the heating of the lining hose and thus the curing of the resin.

The previously described lining hose together with the curing device advantageously forms a system for the renovation of an (e.g. underground) conduit or pipe.

This allows a method for renovating an underground conduit or pipe to be carried out, having the following steps:
inserting a lining hose into the conduit or pipe, wherein the lining hose has at least one fabric or nonwoven layer, which is impregnated or saturated with a thermally curable liquid resin containing magnetic particles, in particular nanoparticles, and
curing the resin by applying an alternating magnetic field to the lining hose.

In the following, exemplary embodiments of the invention are explained in more detail on the basis of the drawings. In the figures:

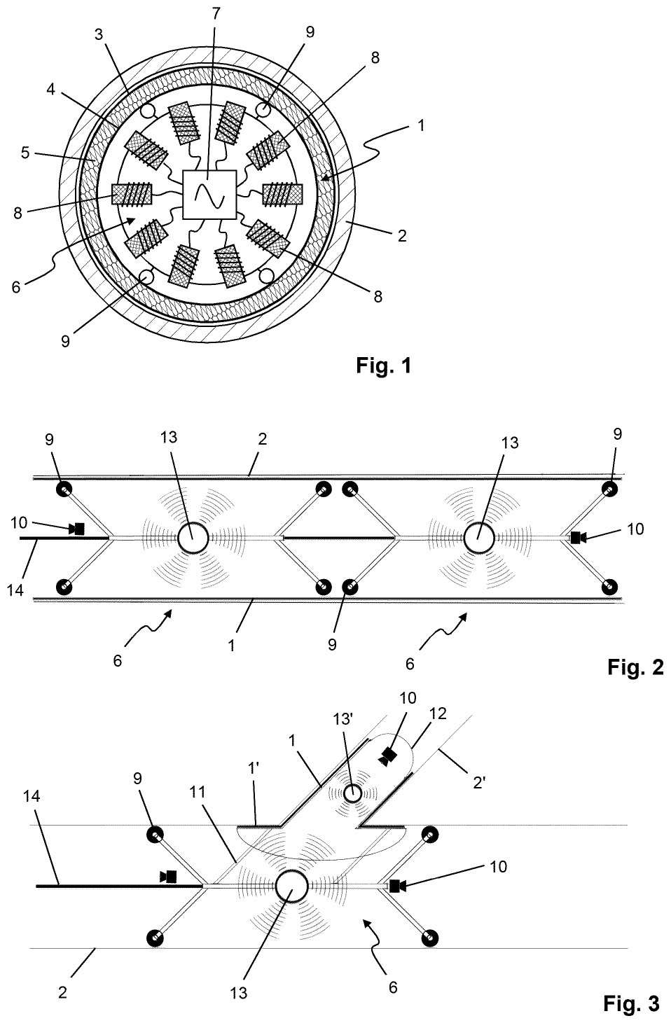

FIG. 1: schematically shows a cross-section of a wastewater pipe to be renovated with a lining hose and curing device drawn into it;

FIG. 2: schematically shows a longitudinal section of a wastewater pipe to be renovated with a curing device located in it;

FIG. 3: schematically shows a section of a wastewater pipe with a side inlet to be renovated, wherein a hat-shaped lining hose is drawn into the side inlet, with a hat packer located in the wastewater pipe.

FIG. 1 shows a lining hose 1 inserted into a wastewater pipe 2 to be renovated. The lining hose 1 has an outer film 3 and an inner film 4. There is a nonwoven layer 5 therebetween, which is saturated with a curable liquid resin. The resin is, for example, a thermally curable epoxy resin that can be converted into a thermosetting plastic by heating. Magnetic nanoparticles are added to the resin. These have a diameter of approx. 20 nm and consist of MnₓZn₁₋ₓFe₂O₄. The resin that contains nanoparticles can be heated by applying an alternating magnetic field to bring about curing. A curing device 6 is used to generate the alternating magnetic field. This comprises an alternating current source 7 as the magnetic field generator, which supplies current to a plurality of magnetic field coils 8 distributed over the circumference of the curing device 6 and oriented radially with respect to the pipe 2, for example at a frequency of 400 kHz. The magnetic field coils 8 are solenoid coils with a core. The magnetic field generated by the magnetic field coils 8 when supplied with current by the alternating current source 7 passes through the lining hose 1 and causes inductive heating of the resin mixed with the nanoparticles. Guide rollers 9 guide the curing device 6 in the wastewater pipe 2.

In FIG. 1, the wastewater pipe 2 has a circular cross-section. The invention is equally suitable for renovating conduits or pipes with other cross-sectional profiles, e.g. egg-shaped profiles or box profiles (e.g. in ventilation conduits).

In FIG. 2, two curing devices 6 are connected together as modules to form a flexible chain. Each module has a magnetic field generator 13. In practice, the chain can comprise significantly more than two modules. As a flexible chain, the curing devices 6, each of which generates an alternating magnetic field, can also be guided through curved pipe strings without any problems. A camera 10 is arranged at the front and rear end of each chain to monitor and document the renovation work. Via rollers 9 arranged on each module, the chain is supported on the inner wall of the pipe 2 with the lining hose 1 drawn into it.

In the variant shown in FIG. 3, the curing device 6 is integrated into a so-called hat packer. With a hat packer, damaged branches can also be repaired and renovated. FIG. 3 shows a wastewater pipe 2 with a side inlet 2′. The lining hose 1 inserted into the side inlet 2′ here has a collar 1′ on its end that remains in the main pipe 2, such that the overall shape is that of a hat with a brim. Accordingly, such lining hoses are also called hat profiles. The packer is equipped with a shield 11 that can be pressed hydraulically, pneumatically or electrically against the inner wall of the main pipe 2. With the shield 11, the brim of the hat profile is pressed against the inner wall of the pipe 2. A bladder 12 is arranged on the shield 11, which can be expanded by means of a fluid (e.g. compressed air) and thus presses the hat profile against the inner wall of the side inlet 2′. A separate magnetic field generator 13′ is positioned in the side inlet 2′ in order to cure this area. One or more generators 13 can be provided in the main pipe 2.

The curing device 6 or the packer is controlled and supplied with electrical energy from above ground via a multi-core cable 14.

In possible embodiments, the magnetic field generators 13 are arranged on the axis of the pipe 2. They can also be arranged eccentrically. A movable arrangement of the magnetic file generator(s) 13, 13′ on the curing device 6 is also conceivable, for example, in order to bring the magnetic field generator 13, 13′ as close as possible to the inner surface of the lining hose 1 in a flexible manner and thus efficiently generate the magnetic field of sufficient strength at the location of the lining hose 1.

### LIST OF REFERENCE NUMERALS

1 Lining hose
1′ Collar/brim of a hat profile
2 Pipe
2 Side inlet
3 Outer film
4 Inner film
5 Fabric/nonwoven layer
6 Curing device
7 Alternating current generator
8 Magnetic field coil
9 Guide roller
10 Camera
11 Shield
12 Bladder
13 Magnetic field generator
13′ Magnetic field generator in side inlet
14 Cable

1. Lining hose (1) for renovating a conduit or pipe (2), having at least one fabric or nonwoven layer (5) which is impregnated or saturated with a curable liquid resin,
wherein the resin can be thermally cured and contains magnetic particles or nanoparticles.

2. Lining hose according to claim 1, wherein the resin that contains particles or nanoparticles can be converted into a thermosetting plastic by applying an alternating magnetic field.

3. Lining hose according to claim 1, wherein the resin can be cured by means of frontal polymerization.

4. Lining hose according to claim 1, wherein the fabric or nonwoven layer (5) is surrounded by an outer film (3) that comes into contact with the inner wall of the conduit or pipe (2) to be renovated.

5. Lining hose according to claim 1, wherein the fabric or nonwoven layer (5) encloses an inner film (4) that comes into contact with a fluid flowing in the conduit or pipe (2) to be renovated.

6. Lining hose according to claim 1, wherein the magnetic particles or nanoparticles have a Curie temperature of less than 250° C., preferably less than 200° ° C.

7. Lining hose according to claim 1, wherein the magnetic nanoparticles have a diameter of less than 100 nm, preferably less than 50 nm, particularly preferably less than 20 nm.

8. Lining hose according to claim 1, wherein the magnetic nanoparticles contain or consist of MnₓZn₁₋ₓFe₂O₄.

9. Lining hose according to claim 8, characterized in that the resin that the Curie temperature of the magnetic nanoparticles is adapted to the curing temperature of the resin by adjusting the ratio of Mn to Zn.

10. Lining hose according to claim 1, wherein the resin is an epoxy resin.

11. Curing device (6) for curing a lining hose (1) inserted into a conduit or pipe (2) to be renovated, having at least one generator (13) that can be inserted into the conduit or pipe (2) and controlled from outside the conduit or pipe,
wherein the generator (13) is designed to generate an alternating magnetic field penetrating the lining hose (1).

12. Device according to claim 11, wherein the generator (13) generates the magnetic field at a frequency between 100 kHz and 1 MHZ, preferably between 200 kHz and 800 kHz, particularly preferably between 300 kHz and 600 KHz.

13. Device according to claim 11, wherein the generator (13) comprises at least one alternating current source (7) and at least one magnetic field coil (8), preferably a solenoid coil, connected thereto.

14. Device according to claim 11, wherein the generator (13) is designed to generate the alternating magnetic field at the location of the lining hose (1) with a strength of 1-50 mT, preferably 5-20 mT.

15. Device according to claim 11, wherein characterized by guide means (9) for guiding the generator (13) on the inside of the lining hose (1) inserted into the conduit or pipe (2) to be renovated.

16. Device according to claim 11, characterized by at least one camera (10) for inspecting the inside of the conduit or pipe (2) lined with the lining hose (1), and/or at least one temperature sensor for detecting the temperature at the inner surface of the lining hose (1).

17. System for renovating a conduit or pipe, having a lining hose (1) according to claim 1 and a device (6) according to any one of claims 11 to 16.

18. Method for renovating a conduit or pipe (2), having the following steps:
inserting a lining hose (1) into the conduit or pipe (2), wherein the lining hose has at least one fabric or nonwoven layer (5), which is impregnated or saturated with a thermally curable liquid resin containing magnetic particles, in particular nanoparticles,
curing the resin by applying an alternating magnetic field to the lining hose (1).

19. Method according to claim 18, wherein the lining hose (1) is designed according to any one of claims 1 to 10.

20. Method according to claim 18, wherein the curing of the resin is carried out using a device (6) according to any one of claims 11 to 16.
